(19) United States
(12) Patent Application Publication
(10) Pub. No.: US 2016/0136697 A1
(43) Pub. Date: May 19, 2016

(54) HELMET CLEANER

(71) Applicants: Jae San CHO, Ansan-si (KR); Mi Young HAM, Ansan-si (KR); Soo Jin CHO, Ansan-si (KR); Woo Seok CHO, Ansan-si (KR); Soon Rae KIM, Gwangju-si (KR); Young Rok KIM, Daejeon (KR); Hyo Chang JUNG, Gwangju-si (KR)

(72) Inventors: Jae San CHO, Ansan-si (KR); Mi Young HAM, Ansan-si (KR); Soo Jin CHO, Ansan-si (KR); Woo Seok CHO, Ansan-si (KR); Soon Rae KIM, Gwangju-si (KR); Young Rok KIM, Daejeon (KR); Hyo Chang JUNG, Gwangju-si (KR)

(21) Appl. No.: 14/926,130

(22) Filed: Oct. 29, 2015

(30) Foreign Application Priority Data
Nov. 19, 2014 (KR) 10-2014-0161372

(51) Int. Cl. B08B 3/02; B08B 5/02; B08B 7/04; B08B 1/00

(52) U.S. Cl. CPC B08B 3/024; B08B 1/002; B08B 5/02; B08B 7/04

(57) ABSTRACT

A helmet cleaner includes a casing providing a sealed washing space and having a door to open or dose the washing space, a helmet support provided at a predetermined height in the washing space and supporting a helmet so that a convex surface of the helmet is directed upwards, a first nozzle part provided on a ceiling inside the washing space to jet water or compressed air to the convex surface of the helmet supported by the helmet support, a second nozzle part provided on a floor inside the washing space to jet water or compressed air to a concave surface of the helmet supported by the helmet support, a washing water supplying pump supplying water to the first and second nozzle parts, and an air pump supplying compressed air to the first and second nozzle parts.

### CROSS-REFERENCE TO RELATED APPLICATIONS

This patent application claims priority under 35 U.S.C. § 119 to Korean Patent Application No. 10-2014-0161372, filed on Nov. 19, 2014, in the Korean Intellectual Property Office, the disclosure of which is incorporated by reference herein in its entirety.

### TECHNICAL FIELD

Embodiments of the present disclosure relate to helmet cleaners or helmet washers, and more specifically, to helmet cleaners or washers that may automatically wash helmets when the helmets are put in a sealed casing.

### DISCUSSION OF RELATED ART

Helmets are used for sports or leisure activities such as playing the baseball, ski, or roller skate or driving auto-bikes. Safety helmets are used to protect the user's head in various construction sites that may be in danger.

A helmet includes a shell-shaped body formed of a hard polymer, a head band provided in the body to support the user's head, a chin strap to fasten the body to the user's head, and a head band adjuster to adjust the head band to fit the user's head.

Helmets are typically used in physical activities and their head bands easily get wet by sweat running down the user's scalp or forehead. Leaving this aside a long time may cause unsanitary situations such as odor or molds.

For that reason, frequent washing is preferable, but it is not easy to clean a helmet due to its complicated structure. There is a need for an apparatus, machine or method for easier cleaning or washing for helmets.

### SUMMARY

According to an embodiment of the present disclosure, a helmet cleaner comprises a casing providing a sealed Washing space and having a door to open or close the washing space a helmet support, provided at a predetermined height in the washing space and supporting a helmet so that a convex surface of the helmet is directed upwards, a first nozzle part provided on a ceiling inside the washing space to jet water or compressed air to the convex surface of the helmet supported by the helmet support, a second nozzle part provided on a floor inside the washing space to jet water or compressed air to a concave surface of the helmet supported by the helmet support, a washing water supplying pump supplying water to the first and second nozzle parts, and an air pump supplying compressed air to the first and second nozzle parts.

The washing space may be partitioned into two or more unit spaces by a barrier wall. The helmet support, the first nozzle part, and the second nozzle part may he installed in each of the unit spaces so that a helmet may be individually loaded in each unit space.

The helmet support may include supporting arms respectively projecting from three different inner side walls of the casing to a center of the washing space, and latches respectively coupled to the supporting arms to be slidable along a length direction of the supporting arms to adjust the length projected from the supporting arms depending on the size of the helmet. The latches may he fitted and stuck in the concave portion of the helmet.

The helmet cleaner may further comprise a washer installed in the casing to form a single body to wash clothes. The washer may be operated independently from the washing water supplying pump and the air pump.

The second nozzle part may be provided to move vertically up or down in the washing space.

The helmet cleaner may further comprise an outer brushing part washing an outer surface of the helmet. The outer brushing part may include a brush supporting arm provided to be hung on the ceiling of the casing, to be spinnable about an axis perpendicular to the ground, and to be vertically moved up or down, and a first brush planted into an inside of the brush supporting arm.

The helmet cleaner ma further comprise an inner brushing part washing an inner surface of the helmet. The inner brushing part may include a brush support provided at a side of the second nozzle part, to be spinnable about an axis perpendicular to the ground, and to be vertically moved up or down, and a second brush planted into an outside of the brush support.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a perspective view illustrating a helmet cleaner according to an embodiment of the present disclosure;

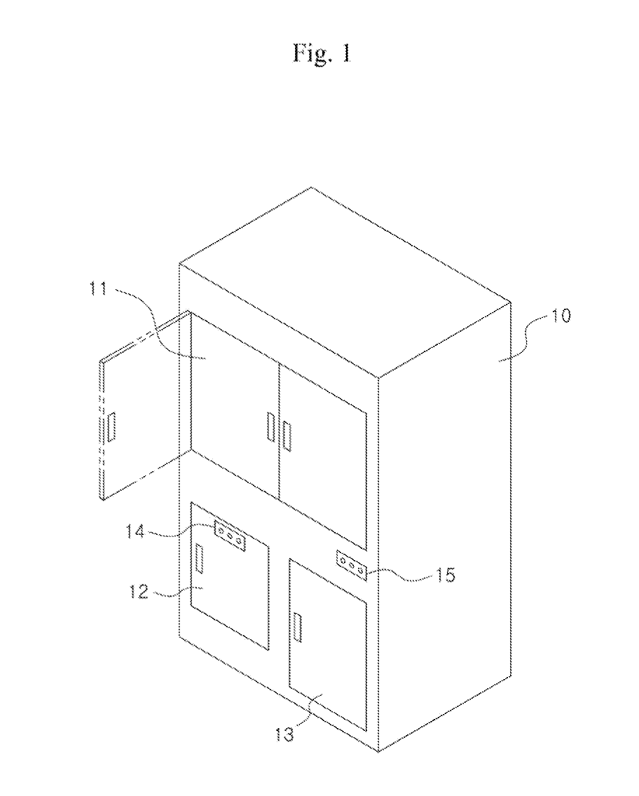

FIG. 2 is a front view illustrating a helmet cleaner according to an embodiment of the present disclosure;

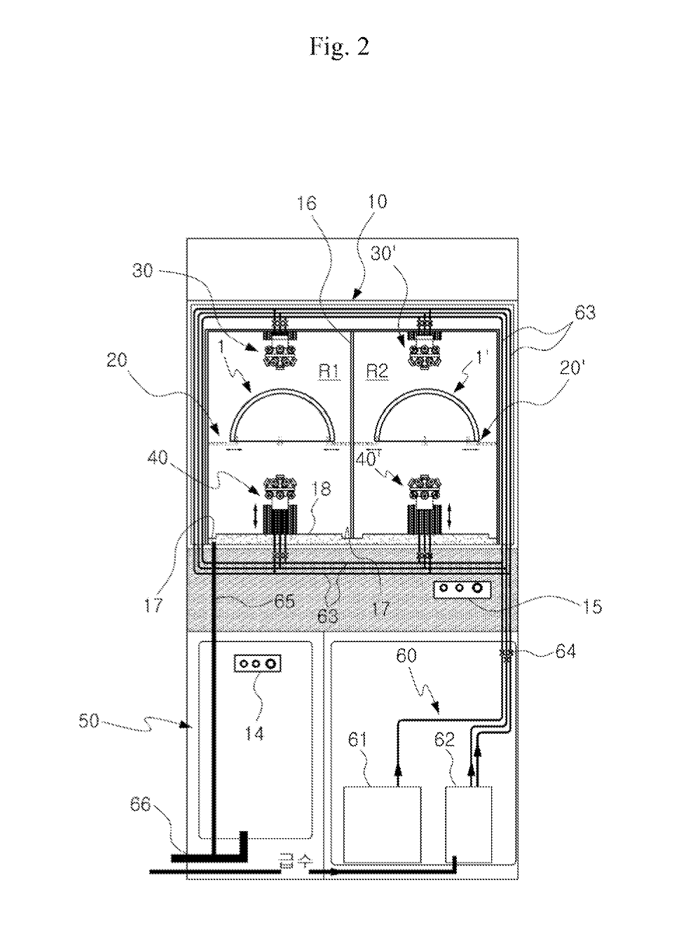

FIG. 3 is a front view illustrating a major part of a helmet cleaner according to an embodiment of the present disclosure;

FIG. 4 is a perspective view illustrating a helmet support of a helmet cleaner according, to an embodiment of the present disclosure;

FIG. 5 is a front view illustrating a major part of a helmet cleaner according to an embodiment of the present disclosure; and

FIG. 6 is a perspective view illustrating a brushing part of a helmet cleaner according to an embodiment of the present disclosure.

### DETAILED DESCRIPTION OF EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a,”“an” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

According to an embodiment of the present disclosure, a helmet cleaner may has a size suited to be placed at a corner or in a cleaning room upon use. The outer look of the helmet cleaner may be determined by a casing 10 providing a sealed washing space R1 and R2. The casing 10 may have a door or doors 11 to open/close the washing space R1 and R2. The doors 11 may be formed of a transparent material and may be provided, in the front surface of the casing 10 to open/close the washing space R1 and R2 in a hinged-door manner. Although two doors 11 are shown in the drawings and the doors 11 are shown as hinged doors, the number or type of the doors 11 is not limited thereto. According to an embodiment of the present disclosure, one door 11 may be provided, and the door 11 may be a slidable door. The number of doors 11 may be substantially the same as the number of unit spaces in the washing space. An air-tight sealing may be provided between the doors 11 and the casing 10 to prevent water leakage. A washer door 12 and a machine room door 13 are provided in the front surface of the casing 10. Control panels 14 and 15 are provided to separately control washing of helmets and washing of clothes.

Helmets 1 and 1′ are loaded by helmet supports 20 and 20′ at a predetermined height (e.g., around a mid-height of the washing space R1 and R2) inside the washing space R1 and R2. The washing space R1 and R2 may be partitioned into two unit spaces by a barrier wall 16 as shown. However, the washing space R1 and R2 may be partitioned into three or more unit spaces as necessary. For example, when a number of helmets may be required to be washed simultaneously, e.g., in a large-scale business site, more than two unit spaces may be used. The number of unit spaces may be selected as necessary.

In the washing space R1 and R2 are installed helmet supports 20 and 20′ to support the helmets 1 and 1′ so that the curved parts (e.g., convex parts) of the helmets 1 and 1′ are directed upwards. The helmet supports 20 and 20′ may be formed to have various shapes. For example, the helmet supports 20 and 20′ may be formed to expose the helmets 1 and 1′ to the washing space R1 and R2 as much as possible.

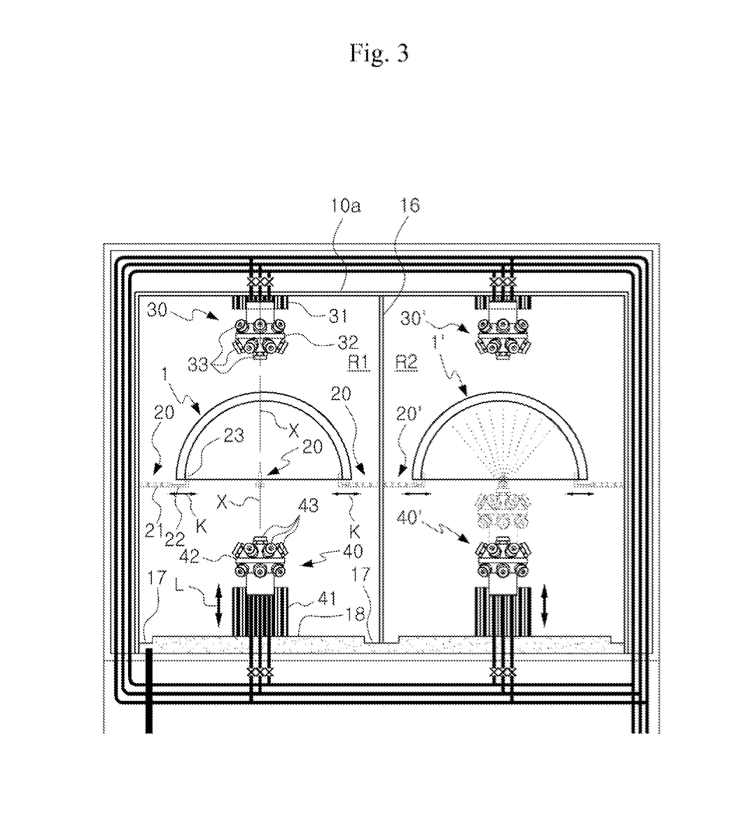

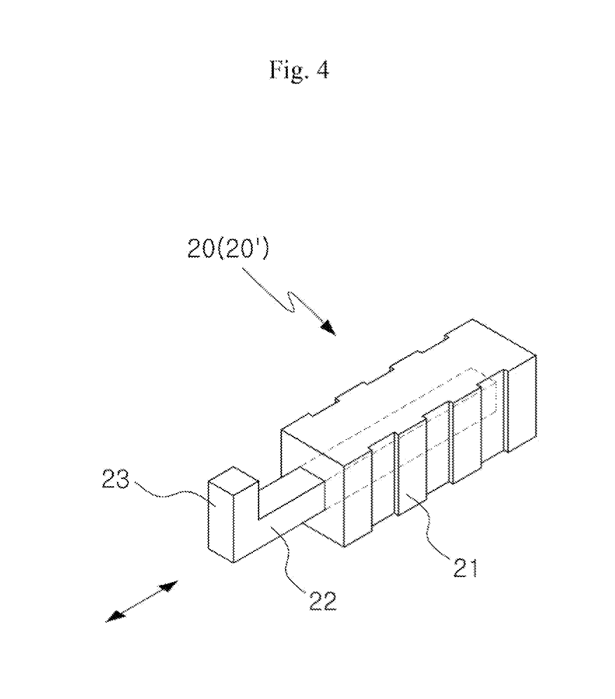

According to an embodiment of the present disclosure, the helmet support 20 includes a supporting arm 21 projecting from an inside wall of the casing 10 to the center of the washing space R1 and R2 and a slider 22 fitted into the supporting arm 21 as shown in FIGS. 3 and 4. Supporting arms 21, respectively, may project from inside walls (e.g., three inside walls except from the inside wall where the door 11 is provided) to the center of each washing space. The supporting arm 21 may have a structure in which the up-to-down height may be adjusted.

At an end of the slider 22 is formed a latch 23 that is bent upwards substantially vertically. The latch 23 is provided to be slidable along a length direction of the supporting arm 21 so as to adjust the length projected from the supporting arm 20 according to the size of the helmets 1 and 1′. Accordingly, the latch 23 may support and hold the helmet 1 or 1′ against the bottom of the inside wall thereof.

First nozzle parts 30 and 30′ are installed on the ceiling 10a of the washing space R1 and R2 to jet washing water or compressed air to the convex portions of the helmets 1 and 1′ supported by the helmet supports 20 and 20′. Second nozzle parts 40 and 40′ are installed on the floor 18 of the washing space R1 and R2 to jet washing water or compressed air to the concave portions of the helmets 1 and 1′ supported by the helmet supports 20 and 20′. Pairs of first nozzle parts 30 and 30′ and second nozzle parts 40 and 40′ are installed for the unit spaces, respectively, which together constitute the washing space R1 and R2. Each helmet 1 or 1′ is bit with washing water or compressed air through a pair of nozzle pans 30 and 40 or a pair of nozzle parts 30′ and 40′.

A fluid supply 60 supplies washing water or creates compressed air and jets the same to the washing space R1 and R2. The fluid supply 60 includes a washing water supplying pump 62 and an air pump 61. The fluid supply 60 is installed in a machine room prepared in the right and lower portion of the casing 10.

The washing water supplying pump 62 is installed inside the casing 10 positioned under the washing space R1 and R2 so as to supply washing water to the first and second nozzle parts 30, 30′, 40, and 40′. The washing water supplying pump 62 is connected with the first and second nozzle parts 30, 30′, 40, and 40′ via a fluid supplying pipe 63. A control valve 64 is provided in the fluid supplying pipe 63.

The air pump 61 to supply compressed air to the first and second nozzle part parts 30, 30′, 40, and 40′ is installed in the same space where the washing water supplying pump 62 is installed. The air pump 61 is connected with the first and second nozzle pans 30, 30′, 40, and 40′ via a fluid supplying pipe 63.

The first nozzle parts 30 and 30′ each includes a number of first unit nozzles 33 to jet washing water through an upper nozzle head 32 in various directions. The first nozzle parts 30 and 30′ are installed as if they are hung on the ceiling 10a by a first nozzle support 31. The several first unit nozzles 33 are coupled to one upper nozzle head 32 to jet water or air in a vertically or inclinedly downward direction.

The second nozzle parts 30 and 30′ each includes a number of second unit nozzles 43 to jet washing water through a lower nozzle head 42 in various directions. The second nozzle parts 40 and 40′ each are installed to stand on the floor 18 by a second nozzle support 41. The several second unit nozzles 43 are coupled to one lower nozzle head 42 to jet water or air in a vertically or inclinedly upward direction. According to an embodiment of the present disclosure, the second nozzle pans 40 and 40′ may be installed to be moved in a vertical direction L with respect to the second nozzle supports 41. The second nozzle parts 40 and 40′ are positioned at a lower level when the helmets 1 and 1′ are loaded, and may be moved up to be positioned near the concave portions of the helmets 1 and 1′ when the cleaner is operated as shown in arrows of FIG. 3. The lower nozzle head 42 may be moved up or down by a pneumatic cylinder or motor. According to an embodiment of the present disclosure, the upper nozzle head 32 and the lower nozzle head 42 may be configured to turn around the vertical axis X.

A detergent may be added to the washing water for better cleaning. A detergent supply (not shown) may be connected to the fluid supplying pipe 63, and a container (not shown) for retaining washing water may be provided. A detergent may be previously retained in the detergent supply or the container, so that the detergent may be supplied together with washing water.

According, to an embodiment of the present disclosure, the cleaner may further include a heater to increase the temperature of the washing space R1 and R2 or washing water. The heater may allow for easier washing. Heating the washing space R1 and R2 may shorten the time to dry while killing germs.

The floor 18 of the washing space R1 and R2 may be made to have steps that allow water to flow to the edges of the washing space. A trench 17 may be formed in an edge of the floor 18 to draw in and drain out the washing water through a washing water drain pipe 65. The washing water drain pipe 65 may be connected to a washer drain pipe 66.

According to an embodiment of the present disclosure, a washer 50 may be added to the casing 10 to form a single body in order to wash or dehydrate clothes or laundry. The washer 50 may be similar in configuration and operation to a regular home washer haying a dehydration function. A washer door 12 is provided at a lower portion in the front surface of the casing 10 to communicate with a space for laundry washing (e.g., a washing tub of the washer 50). The washer 50 may operate independently from the washing water supplying pump 62 and the air pump 61 to wash the helmets 1 and 1′.

By the above configuration, when the cleaner is operated with the helmets 1 and 1′ loaded in the washing space R1 and R2, washing water is supplied to wash the helmets 1 and 1′, and in a predetermined time, the supply of washing water is stopped and compressed air is supplied to dry the helmets 1 and 1′. During this course, a detergent or heat from the heater may also be supplied. When only one helmet is loaded, the cleaner may be set to use only one of the unit spaces R1 and R2. Separately from washing helmets, inner or outer cloth, gloves, or masks may be washed using the washer 50.

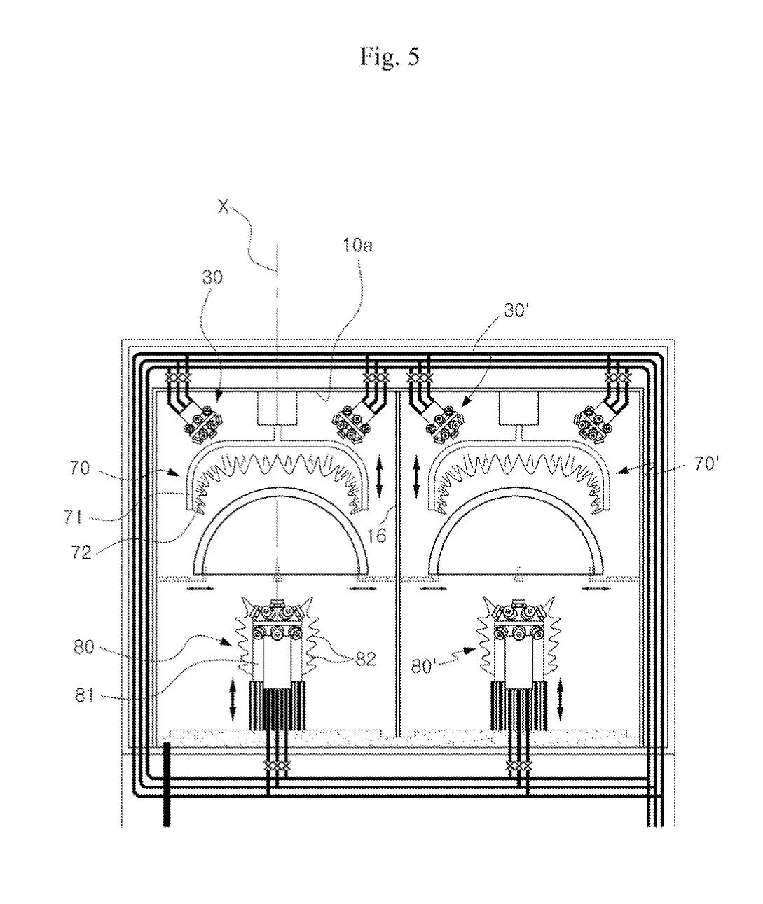

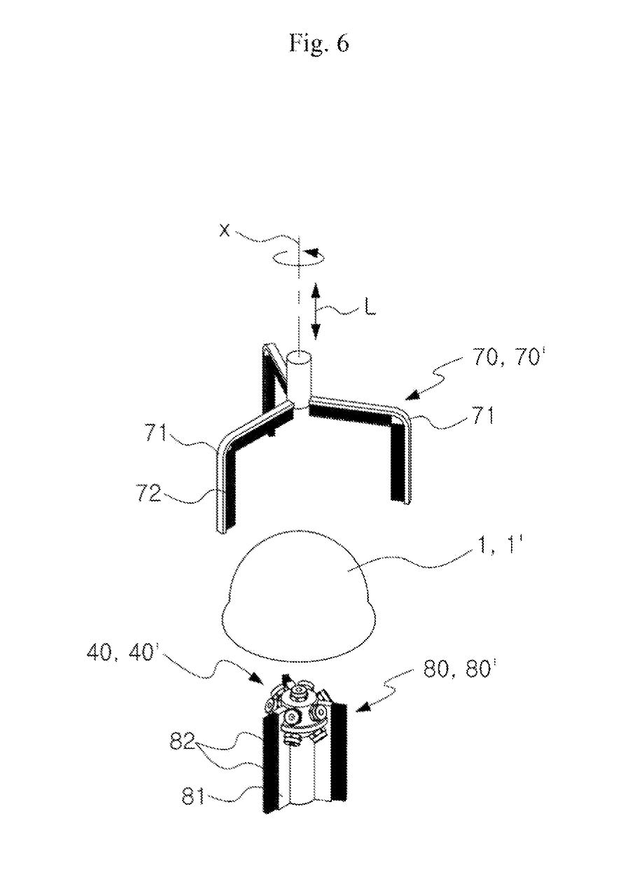

Hereinafter, embodiments of the present disclosure are described in detail with reference to FIGS. 5 to 6.

According to an embodiment of the present disclosure, the cleaner may further include outer brushing parts 70 an d 70′ and inner brushing parts 80 and 80′ to quickly and further clearly wash the inside and outside of the helmets 1 and 1′ through physical contacts.

The outer brushing parts 70 and 70′ each includes brush supporting arms 71 installed to be hung on the ceiling 10a of the casing, to be rotated about an axis X perpendicular to the ground, and to be vertically moved up or down and first brushes 72 planted into the inside of the brush supporting arms 71. Each brush supporting arm 71 is bent in an L shape to surround the outer surface of the helmet 1 or 1′. As shown in FIG. 6, three brush supporting aims 71 may be provided which are spaced apart from each other at to predetermined angle. Each first brush 72 may be formed of cloth or thin thread or strip materials. The first brushes 72 may be together forced to the center by the centrifugal force as the brush supporting arms 71 spin, thereby washing the outer surface of the helmet 1 or 1′.

A configuration for spinning the brush supporting arms 71 or moving the brush supporting arms 71 in the direction (L) marked with the arrow may be apparent to one of ordinary skill in the art, and thus, its detailed description is omitted. The first nozzle parts 30 and 30′ may be installed at corners of the ceiling 10a of the washing space R1 and R2 in order to avoid interference with the brush supporting arms 71.

Inner brushing parts 80 and 80′ are provided in the washing space R1 and R2 to wash or wipe the inside of the helmets 1 and 1′. The inner brushing parts 80 and 80′ each includes a brush support 81 installed on the floor inside the casing, e.g., side of the second nozzle parts 40 and 40′ and a second brush 82 planted in the outer surface of the brush support 81. The second brush 82 may be formed of the same material as the first brush 72. The second brush 82 may have a predetermined length appropriate to wash or wipe the inside of the helmet 1 or 1′. The brush support 81 may be rotated about the axis X perpendicular to the ground and is installed to vertically move up or down. The second brush 82 may be externally expanded or spread by the centrifugal force as the brush support 81 spins, thereby wiping and cleaning the inner surface of the helmet 1 or 1′.

The brushing parts 70, 70′, 80, and 80′ may be operated simultaneously or independently from the nozzle parts 30, 30′, 40, and 40′. This may be determined depending on what washing program is set up. The user may set different washing programs depending, on the degree of contamination of the helmets 1 and 1′. The speed or efficiency of cleaning may be increased by operating the brushes 72 and 82 while supplying detergent, washing water, and compressed air.

According to an embodiment of the present disclosure, there is provided a helmet cleaner that may automatically wash various types of helmets. According to an embodiment of the present disclosure, the helmet cleaner may consecutively perform washing and drying on helmets, enabling quicker and easier cleaning of helmets.

According to embodiments of the present disclosure, there is provided an automated helmet cleaner that allows quicker and easier cleaning, washing, and drying for helmets. The helmet cleaner may wash out the inside of helmets as well as the outside.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A helmet cleaner, comprising:
a casing providing a sealed washing space and having a door to open or close the washing space;
a helmet support provided at a predetermined height in the washing space and supporting a helmet so that a convex surface of the helmet is directed upwards;
a first nozzle part provided on a ceiling inside the washing space to jet water or compressed air to the convex surface of the helmet supported by the helmet support;
a second nozzle part provided on a floor inside the washing space to jet water or compressed air to a concave surface of the helmet supported by the helmet support;
a washing water supplying pump supplying water to the first and second nozzle parts; and
an air pump supplying compressed air to the first and second nozzle parts.

2. The helmet cleaner of claim 1, wherein the washing space is partitioned into two or more trait spaces by a barrier wall, and wherein the helmet support, the first nozzle part, and the second nozzle part are installed in each of the unit spaces so that a helmet may be individually loaded in each unit space.

3. The helmet cleaner of claim 1, wherein the helmet support includes supporting arms respectively projecting from three different inner side walls of the casing to a center of the washing space, and latches respectively coupled to the supporting arms to be slidable along a length direction of the supporting arms to adjust the length projected from the supporting arms depending on the size of the helmet, wherein the latches are fitted and stuck in the concave portion of the helmet.

4. The helmet cleaner of claim 1, further comprising a washer installed in the casing to bun a single body to wash clothes, wherein the washer may be operated independently horn the Washing Water supplying pump and the air pump.

5. The helmet cleaner of claim 1, wherein the second nozzle part is provided to move vertically up or down in the washing space.

6. The helmet cleaner of claim 1, further comprising an outer brushing part washing an outer surface of the helmet, wherein the outer brushing part includes a brush supporting arm provided to be hung on the ceiling of the casing, to be spinnable about an axis perpendicular to the ground, and to he vertically moved up or down, and a first brush planted into an inside of the brush supporting arm.

7. The helmet cleaner of claim 1, further comprising an inner brushing part washing an inner surface of the helmet, wherein the inner brushing part includes a brush support provided at a side of the second nozzle part, to be spinnable about an axis perpendicular to the ground, and to be vertically moved up or down, and a second brush planted into an outside of the brush support.
